(19) United States
(12) Patent Application Publication
(10) Pub. No.: US 2026/0322095 A1
(43) Pub. Date: Oct. 15, 2026

(54) BUSBAR SYSTEM

(71) Applicant: BD ENGINE BRAKE, Abbotsford (CA)

(72) Inventors: Brian Sze Ying Wan, Mission (CA); Jeffrey William Harris, Langley (CA); Shayne Donovan Harder, Abbotsford (CA); Gregory Alan Tucker, Abbotsford (CA)

(73) Assignee: BD ENGINE BRAKE, Abbotsford (CA)

(21) Appl. No.: 19/178,776

(22) Filed: Apr. 14, 2025

(51) Int. Cl. H02G 5/02

(52) U.S. Cl. CPC H02G 5/02

(57) ABSTRACT

A busbar system for a grid heater is provided. The busbar system includes a lower busbar having a lower busbar body with a first leg at a first end of the lower busbar body and a second leg at a second end of the lower busbar body, opposite the first end. The first leg comprises a first coupling feature integrally coupled to a distal end of the first leg, and the second leg is adapted for coupling to a grid heater.

### TECHNICAL FIELD

The disclosure relates generally to a busbar system adapted for use with a grid heating system, such as that which may be employed in connection with an engine, such as a diesel engine.

### BACKGROUND

Grid heaters can be used for a variety of tasks, including pre-heating air fed to an engine (e.g., a diesel engine). Benefits of grid heaters in such arrangements include easing cold weather starting, increasing fuel efficiency, reducing emissions, and increasing the longevity of the diesel engine. Such grid heaters can be based on resistance heating principles and a busbar can be used to provide electricity to the grid heater.

### SUMMARY

In some aspects, a busbar system for a grid heater is provided. The busbar system can include a lower busbar having a lower busbar body with a first leg at a first end of the lower busbar body and a second leg at a second end of the lower busbar body, opposite the first end. The first leg can include a first coupling feature integrally coupled to a distal end of the first leg, and the second leg is adapted for coupling to the grid heater.

In some embodiments, the first coupling feature comprises a first threaded opening extending into a distal end of the first leg toward the lower busbar body. In some embodiments, the first coupling feature comprises a first threaded rod extending away from a distal end of the first leg.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description.

FIG. 1 illustrates an exploded view of a busbar system according to an embodiment described herein.

FIG. 2 illustrates an assembled, partially transparent, view of a busbar system of FIG. 1.

FIG. 3 illustrates a lower busbar according to an embodiment described herein.

FIG. 4 illustrates a lower busbar according to another embodiment described herein.

FIG. 5 illustrates a perspective view of a lower busbar according to an embodiment described herein.

FIG. 6 illustrates a top view of the lower busbar of FIG. 5.

FIG. 7 illustrates a front view of the lower busbar of FIG. 5.

FIG. 8 illustrates a perspective view of an upper busbar according to an embodiment described herein.

FIG. 9 illustrates a top view of the upper busbar of FIG. 8.

FIG. 10 illustrates a perspective view of the insulating enclosure of the upper busbar of FIG. 8.

FIG. 11 illustrates a perspective view of the conductive upper busbar element of FIG. 8.

FIG. 12 illustrates a perspective view of a conductive upper busbar element according to an embodiment described herein.

FIG. 13 illustrates a perspective view of a conductive upper busbar element according to another embodiment described herein.

FIG. 14 illustrates a grid heater with which the busbar system described herein may be used.

FIG. 15 illustrates a perspective view of a busbar system described herein installed on the grid heater of FIG. 14.

FIG. 16 illustrates an exploded side view showing an embodiment of the attachment of the lower busbar to the grid heater heating element and the grid heater mount.

FIG. 17 illustrates an exploded view of a busbar system using the lower busbar of FIG. 4 according to an embodiment described herein.

FIG. 18 illustrates an upper busbar according to the prior art.

FIG. 19 illustrates a lower busbar according to the prior art.

### DETAILED DESCRIPTION

The following discussion omits or only briefly describes conventional features of grid heaters and busbars that are apparent to those skilled in the art. It is noted that various embodiments are described in detail with reference to the drawings, in which like reference numerals represent like parts and assemblies throughout the several views. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations.

Unless otherwise specifically defined herein, all terms are to be given their broadest reasonable interpretation including meanings implied from the specification as well as meanings understood by those skilled in the art and/or as defined in dictionaries, treatises, etc. It must also be noted that, as used in the specification and the appended claims, the singular forms “a,” “an” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. In the description, relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “above” versus “below,” “inwardly” versus “outwardly,” “longitudinal” versus “lateral,” and the like are to be interpreted relative to one another or relative to an axis of elongation, or an axis or center of rotation, as appropriate. Terms concerning attachments, coupling, and the like, such as “connected” and “interconnected,” refer to a relationship wherein structures are secured or attached to one another either directly or indirectly through intervening structures, as well as both movable or rigid attachments or relationships, unless expressly described otherwise. The terms “operatively connected,” “operably connected,” and the like are such attachments, couplings, or connections that allow the pertinent structures to operate as intended by virtue of that relationship.

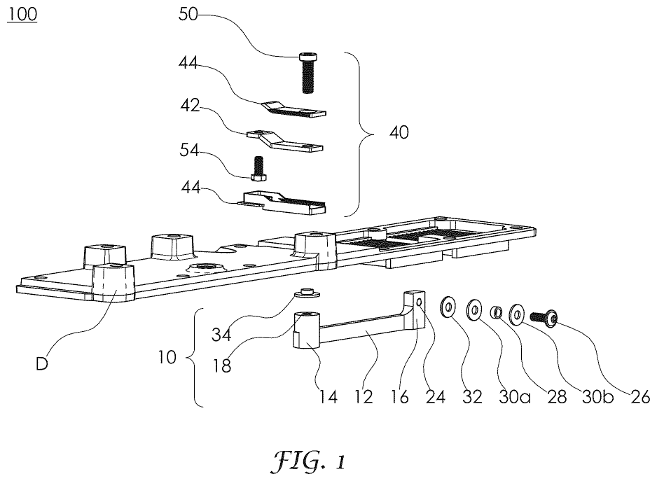

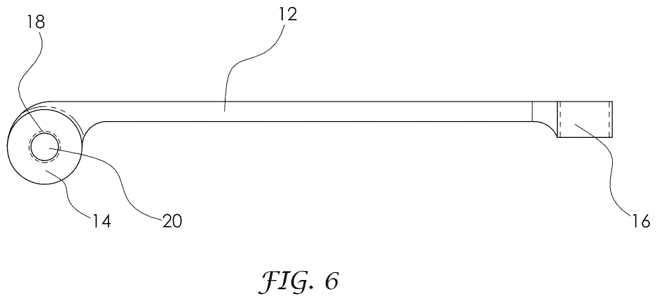

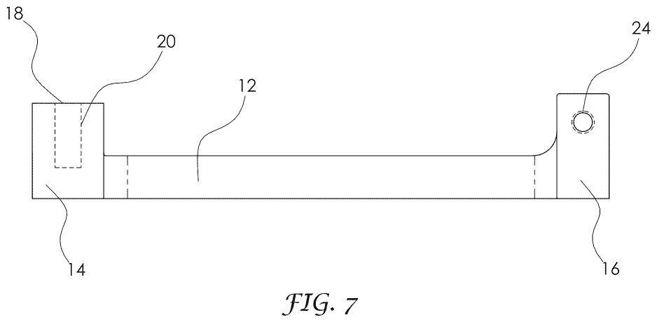

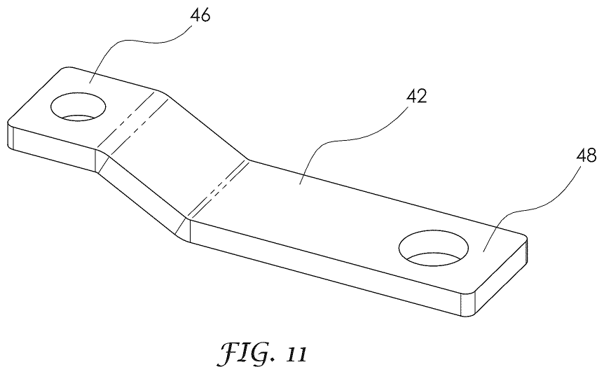

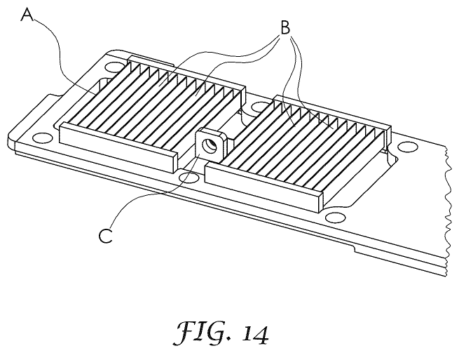

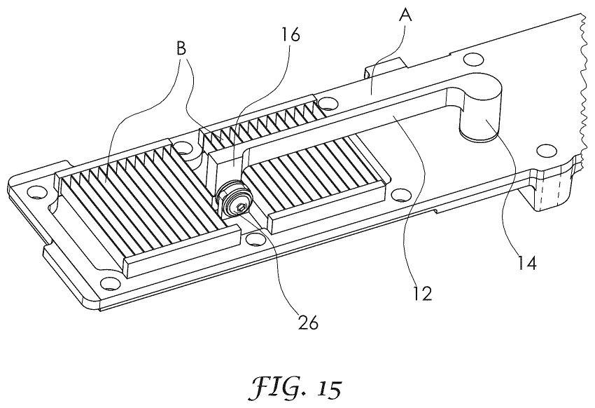

Embodiments of the present disclosure relate generally to a busbar system 100 for a grid heater A. As shown in FIGS. 1-17, the busbar system 100 includes a lower busbar 10 having a lower busbar body 12 with a first leg 14 at a first end of the lower busbar body 12 and a second leg 16 at a second end of the lower busbar body 12, opposite the first end. The first leg 14 includes a first coupling feature 18 integrally coupled to a distal end of the first leg 14, and the second leg 16 is adapted for coupling to the grid heater A. As used herein, integrally coupled to includes integrally incorporated into (e.g., includes a threaded opening 20 and a threaded rod 22).

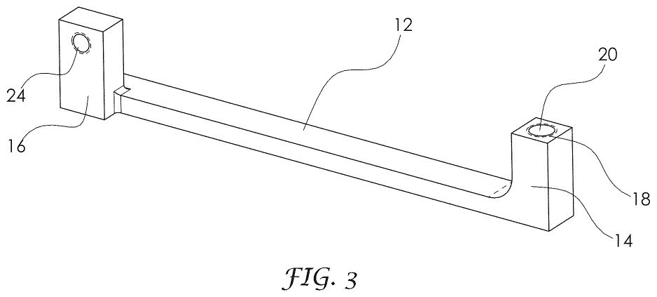

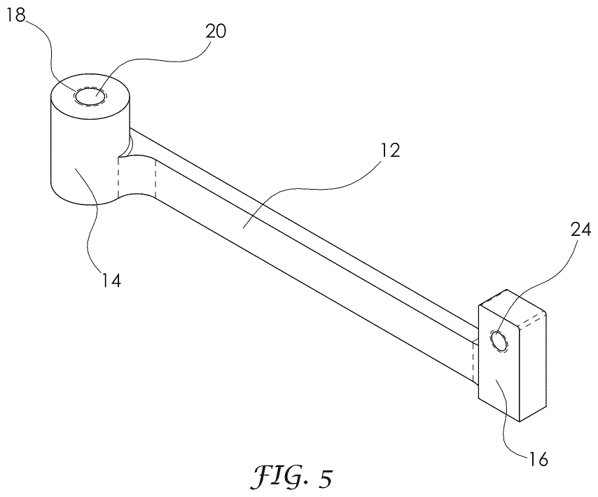

In some embodiments, as shown in FIGS. 3, 5, 6, and 7, the first coupling feature 18 includes a first threaded opening 20 extending into a distal end of the first leg 14 toward the lower busbar body 12. In some such embodiments, as best shown in FIG. 5, the first threaded opening 20 extends generally perpendicular to the longitudinal direction of the lower busbar body 12.

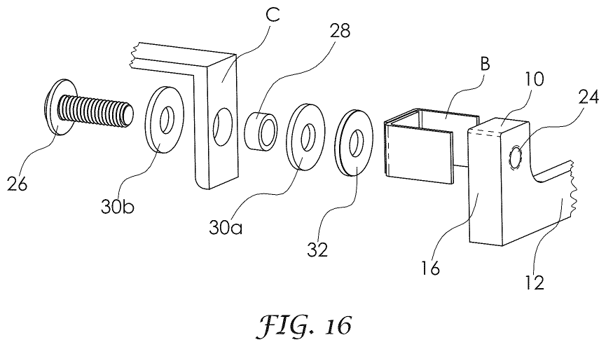

In some embodiments, electrically insulating sleeves, washers, etc. are used to prevent conductive components of the busbar system 100 from contacting metal outside of the intended circuit, which would cause a short in the busbar system 100. For example, an insulating sleeve 34 (e.g., an insulating shoulder washer) is shown in FIG. 1 to prevent the first coupling feature 18 from being in electrical communication with the intake grid heater assembly D, and an insulating insert 28 is shown in FIG. 16 to prevent the grid heater fastener 26 from being in electrical communication with the grid heater mount C. Additional electrically insulating components may be used as appropriate to produce the desired flow of current through the busbar system 100.

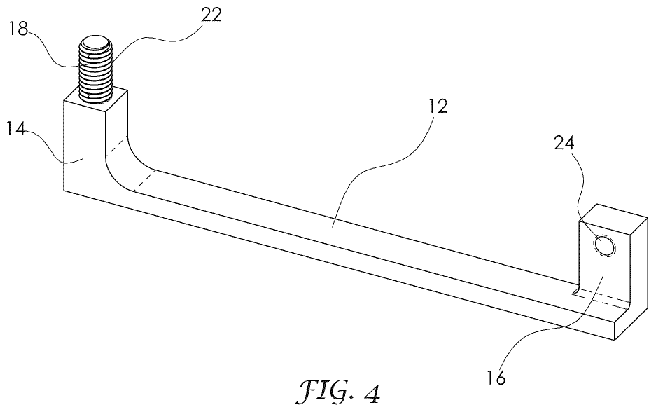

In some embodiments, as shown in FIG. 4, the first coupling feature 18 includes a first threaded rod 22 extending away from a distal end of the first leg 14. In some such embodiments, the first threaded rod 22 extends generally perpendicular to the longitudinal direction of the lower busbar body 12.

As evident from FIGS. 3-7, in some embodiment, the first leg 14, the lower busbar body 12, and the second leg 16 together have a generally U-shape.

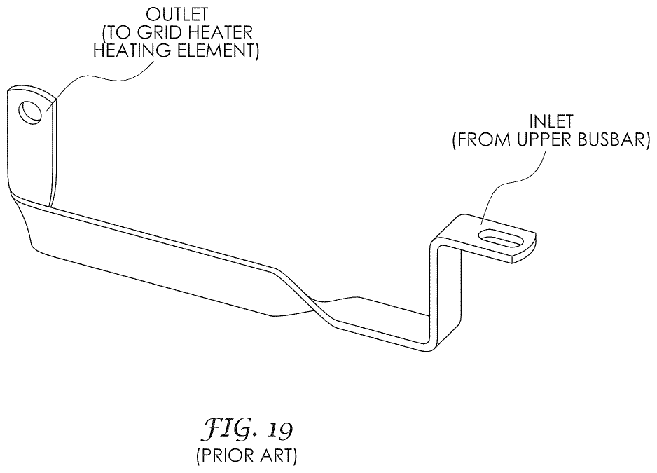

In some embodiments, as shown in FIGS. 3-7, the lower busbar body 12 has a generally uniform cross-section. In some embodiments, as shown in FIGS. 3-7, the lower busbar body 12 has an elongated shape that extends in a longitudinal direction from the first leg 14 to the second leg 16. In some embodiments, as shown in FIGS. 3-7, the lower busbar body 12 can have a rectangular cross-section. It should be noted that a generally rectangular bar that is rotated or twisted, such as the one shown in FIG. 19, would not be considered to have a uniform cross-section even if the original bar did have a uniform cross-section prior to being rotated or twisted.

In some embodiments, the second leg 16 is adapted to be electrically coupled to a grid heater heating element B. In some embodiments, the second leg 16 is adapted to be directly electrically coupled to a grid heater heating element B. As used herein, directly electrically coupled indicates that the second leg and the grid heater heating element B are in direct contact with one another (e.g., the electrical contact is not via an intermediate component, such as a fastener 26).

In some embodiments, the second leg 16 comprises a second opening 24 adapted for receiving a grid heater fastener 26 for physically coupling the lower busbar 10 to the grid heater heating element B. In some embodiments, the second opening extends laterally through the second leg 16. In some embodiments, the grid heater fastener 26 does not electrically couple the lower busbar 10 and the grid heater heating element B. In some embodiments, the fastener 26 is electrically isolated from the lower busbar 10.

In some embodiments, as best shown in FIGS. 3, 4, 5, and 16, the second opening 24 is a threaded opening. In some embodiments, the grid heater fastener 26 is secured within the second opening 24 using a thread locker or EMUGE self-lock threading.

In some embodiments, as best seen in FIG. 16, the second leg 16 is adapted for physically coupling to a grid heater heating element B and a grid heater mount C. For instance, the second opening 24 can be adapted to align with an opening in both the grid heater heating element B and the grid heater mount C, so that the grid heater fastener 26 can pass through the openings and secure them together.

As will be understood, the grid heater heating element B is designed for resistive heating and is not generally adapted for providing structural support. Thus, a grid heater mount C can be provided to provide structural support for the lower busbar 10.

In such embodiments, the lower busbar 10 can be electrically isolated from the grid heater mount C to prevent shorting of the circuit supplying current from the lower busbar 10 to the grid heater heating element B. In some embodiments, as shown in FIG. 16, an insulating insert 28 can be positioned between an opening in the grid heater mount C and a threaded rod of the grid heater fastener 26 and insulating washers 30a and 30b can be positioned on either side of the grid heater mount C to provide electrical isolation from the electricity in the lower busbar and, optionally, the grid heater fastener 26. One or more metal washers 32 can also be included to assist with securing the lower busbar to the grid heater heating element B and/or the grid heater mount C.

In some embodiments, the lower busbar body 12, the first leg 14, and the second leg 16 are formed of a unitary metal block. In some embodiments, the lower busbar body 12, the first leg 14, and the second leg 16 are formed by a technique selected from casting, forging, welding, stamping, milling, forming, or printing.

In some embodiments, the lower busbar body 12, the first leg 14, and the second leg 16 comprise an electrically conductive material. In some embodiments, the electrically conductive material comprises a material selected from the group consisting of steel, copper, tin, zinc, aluminum, iron, alloys thereof, and combinations thereof.

In some embodiments, as shown in FIGS. 1, 2, 8-13, and 17, the busbar system 10 also includes an upper busbar 40 comprising a conductive upper busbar element 42 within an insulating enclosure 44. The upper busbar 40 includes an input contact 46 and an output contact 48 separated from the input contact 46. The busbar system also includes a connecting fastener 50 adapted to couple the output contact 48 to the first coupling feature 18 of the lower busbar 10. In some embodiments, the first coupling feature 18 can use EMUGE self-lock threading or a thread locker to prevent the connecting fastener 50 from loosening after attachment.

In some embodiments, the insulating enclosure 44 is designed to prevent the conductive upper busbar element 42 from contacting a conductive material other than a path to the lower busbar from the connecting fastener 50 and the first coupling feature 18. For example, the upper busbar 40 generally rests on a grid heater assembly plate D, which is made of metal. Thus, if the conductive upper busbar element 42 contacted the grid heater assembly plate D, it would cause a short circuit.

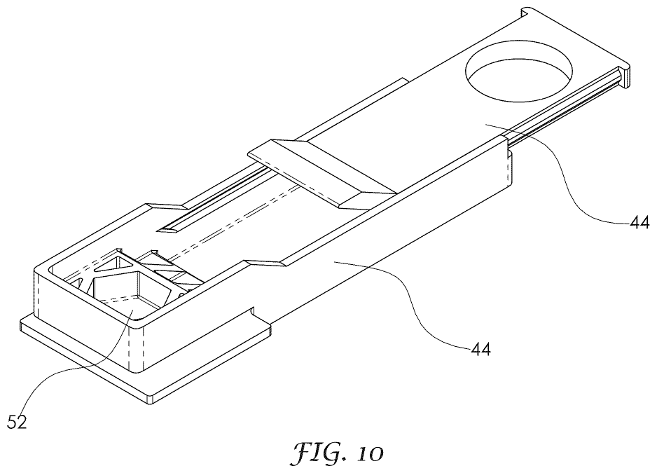

In some embodiments, the insulating enclosure 44 can be a single piece of insulating material. However, the insulating enclosure 44 can also be two or more pieces of insulating material in other embodiments. An example of a two-piece insulating enclosure 44 is shown in FIGS. 1 and 10.

In some embodiments, the connecting fastener 50 is adapted to electrically couple the upper busbar 40 to the lower busbar 10.

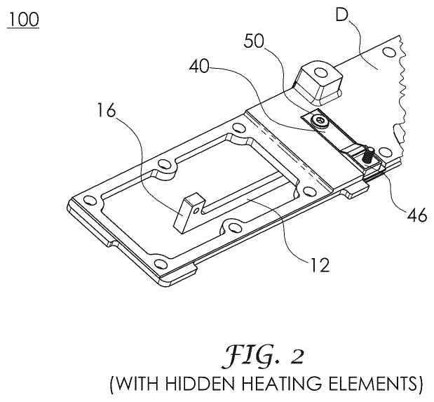

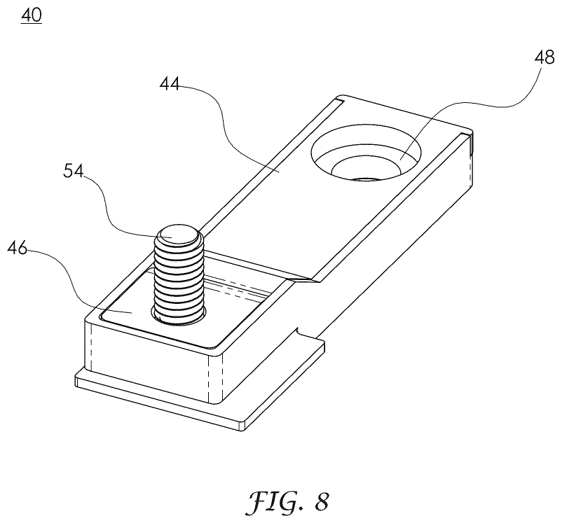

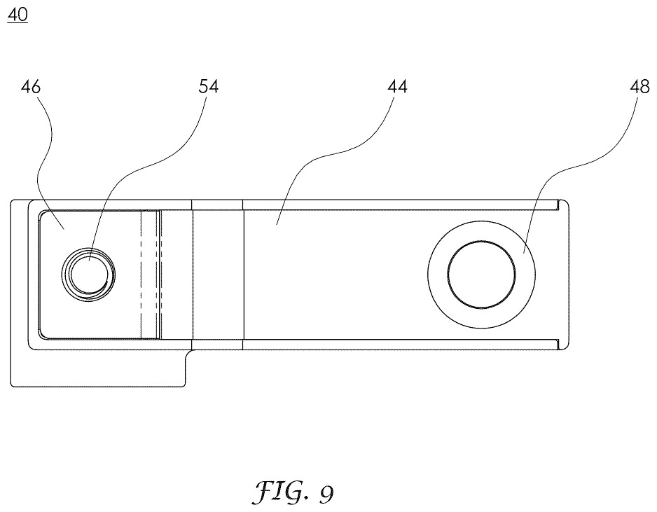

In some embodiments, the connecting fastener 50 is a bolt or screw that passes through a grid heater assembly plate D and the first coupling feature 18 is a first threaded opening 20. While other combinations are possible, examples of such an embodiment could include a lower busbar 10 as shown in FIGS. 3, 5, or 6 combined with an upper busbar 40 as shown in FIG. 8 or 9 in the configuration shown in FIGS. 1 and 2.

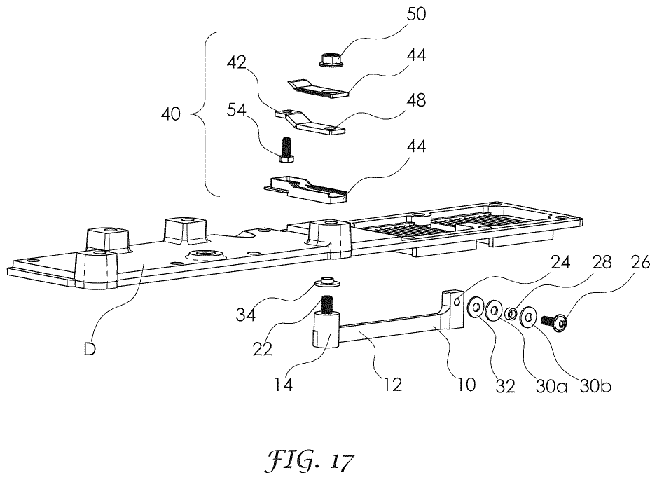

In some embodiments, the connecting fastener 50 is a nut and the first coupling feature 18 is a threaded rod 22 that passes through the grid heater assembly plate D. While other combinations are possible, examples of such an embodiment could include a lower busbar 10 as shown in FIG. 4 combined with an upper busbar 40 as shown in any of FIGS. 8-13. An example of such an embodiment is shown in FIG. 17.

In some embodiments, the conductive upper busbar element 42 comprises a material selected from the group consisting of steel, copper, tin, zinc, aluminum, iron, alloys thereof, and a combination thereof.

In some embodiments, the input contact 46 is accessible from a top of the upper busbar 40. In some embodiments, the input contact 46 is not accessible from the bottom of the upper busbar 40.

In some embodiments, the input contact 46 includes a second coupling feature 54 for coupling to an electrical source. In some embodiments, the electrical source is selected from a generator, an engine, an alternator, or a battery.

In some embodiments, as shown in FIGS. 1, 2, 8, 9, and 13, the second coupling feature 54 comprises an input fastener extending upward through the input opening. In some embodiments, the input opening is sized to retain the input fastener therein. For example, as most evidence in FIG. 1, the input opening allows the threaded portion of a bolt to pass through, but is smaller than the head of the bolt.

In such embodiments, the insulating enclosure 44 prevents the second coupling feature 54 (e.g., hex head bolt) from contacting a surface under the intake grid heater assembly D. In addition, in some embodiments, as best shown in FIG. 10, the insulating enclosure 44 can include a recess 52 having a geometric shape (e.g., a hexagon) adapted to hold a head of a bolt corresponding to the shape in place. Thus, for example, if the second coupling feature 54 is a hex head bolt, the hex head bolt can be retained in and extend from the input contact 46 and, the recess 52 holds the headed input fastener 54 in place when a fastener (e.g., a nut) is attached to the bolt.

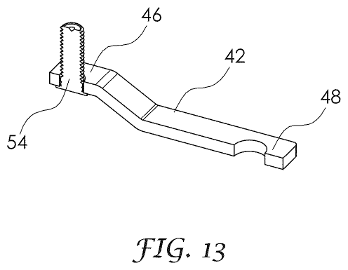

In some embodiments, the headed input fastener 54 can be fixedly attached to the input opening (e.g., a PEM stud). An example of such an embodiment is shown in FIG. 13.

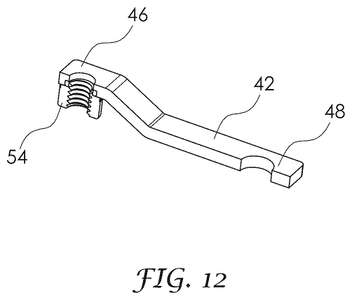

In still another embodiment, as shown in FIG. 12, the second coupling feature 54 can be a threaded opening (e.g., a nut or a threaded opening), which can be used to secure a fastener to the input contact 46. In some embodiments, the nut can be retained within a recess 52, such as the one shown in FIG. 10. In other embodiments, such as the one shown in FIG. 12, the nut can be physically bonded or fused to the input contact.

In some embodiments, the output contact 48 comprises an output opening accessible from a top of the upper busbar 40. In some embodiments, as best shown in FIG. 1, the output opening is adapted for receiving a connecting fastener 50, such as a headed fastener that is secured in the first threaded opening 20 of the lower busbar. In other embodiments, as best shown in FIG. 17, the output contact 48 is an opening adapted for receiving a first threaded rod 22 of the lower busbar and supporting a nut 54 (second coupling feature), which secures the first threaded rod 22.

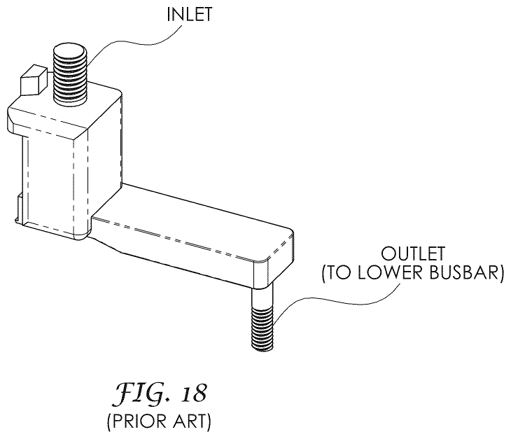

The busbar system 100 described herein are intended to replace, and improve upon, the busbar system provided by the original equipment manufacturer (OEM). Examples of the OEM upper busbar and lower busbar are shown in FIGS. 18 and 19, respectively. When assembled, the connection between the upper busbar (FIG. 18) and the lower busbar (FIG. 19) is achieved using a nut to secure the lower busbar inlet to the screw of the upper busbar outlet. In use, the nut frequently loosens over time, which can interrupt the supply of electricity to the grid heater element. In addition, if the nut comes completely loose, the nut can travel into the engine and cause substantial damage to the engine itself. In contrast, when properly installed, the attachment systems of the busbar systems 100 described herein helps reduce or eliminate the chance of engine damage. For instance, in some instances, the nut attached to the outlet of the lower busbar can loosen and pass into the engine.

In addition, because the electrical connection from the lower busbar to the heating element is through direct electrical contact, not via the fastener, there is less degradation and/or corrosion of the connecting fastener 50.

Furthermore, the uniform cross-section of the lower busbar body 12 increases efficiency of the current flow through the lower busbar (i.e., reduces resistance loses).

As a result of these and other improvements in the design, the busbar system 100 described herein is a much more robust and efficient busbar system for incorporation into a grid heating system, or other similar busbar applications.

The various embodiments described above are provided by way of illustration only and should not be construed to limit the claims attached hereto. Those skilled in the art will readily recognize various modifications and changes that may be made without following the example embodiments and applications illustrated and described herein, and without departing from the spirit and scope of the following claims.

What is claimed is:

1. A busbar system for a grid heater, comprising:
a lower busbar having a lower busbar body with a first leg at a first end of the lower busbar body and a second leg at a second end of the lower busbar body, opposite the first end;
wherein the first leg comprises a first coupling feature integrally coupled to a distal end of the first leg, and the second leg is adapted for coupling to a grid heater.

2. The busbar system of claim 1, wherein the first coupling feature comprises a first threaded opening extending into a distal end of the first leg toward the lower busbar body.

3. The busbar system of claim 1, wherein the first coupling feature comprises a first threaded rod extending away from a distal end of the first leg.

4. The busbar system of claim 1, wherein the first leg, the lower busbar body, and the second leg together have a generally U-shape.

5. The busbar system of claim 1, wherein the lower busbar body has a generally uniform cross-section.

6. The busbar system of claim 1, wherein the second leg is adapted to be directly electrically coupled to a grid heater heating element.

7. The busbar system of claim 1, wherein the second leg comprises a second opening adapted for receiving a fastener for physically coupling the lower busbar to the grid heater heating element.

8. The busbar system of claim 7, wherein the second opening is a threaded opening.

9. The busbar system of claim 6, wherein the second leg is adapted for physically coupling to a grid heater heating element and a grid heater mount.

10. The busbar system of claim 9, wherein the lower busbar is electrically isolated from the grid heater mount.

11. The busbar system of claim 1, wherein the lower busbar body, the first leg, and the second leg are formed of a unitary metal block.

12. The busbar system of claim 1, wherein the lower busbar body, the first leg, and the second leg comprise an electrically conductive material.

13. The busbar system of claim 12, wherein the electrically conductive material comprises a material selected from the group consisting of steel, copper, tin, zinc, aluminum, iron, alloys thereof, and combinations thereof.

14. The busbar system of claim 1, further comprising:
an upper busbar comprising a conductive upper busbar element within an insulating enclosure, comprising an input contact and an output contact separated from the input contact, and a connecting fastener adapted to couple the output contact to the first coupling feature of the lower busbar.

15. The busbar system of claim 14, wherein the connecting fastener is adapted to electrically couple the upper busbar to the lower busbar.

16. The busbar system of claim 14, wherein the conductive upper busbar element comprises a material selected from the group consisting of steel, copper, tin, zinc, aluminum, iron, alloys thereof, and a combination thereof.

17. The busbar system of claim 14, wherein the input contact is accessible from a top of the upper busbar.

18. The busbar system of claim 17, wherein the input contact comprises a second coupling feature for coupling to an electrical source.

19. The busbar system of claim 18, wherein the second coupling feature comprises an input fastener extending upward through the input opening.

20. The busbar system of claim 14, wherein the output contact comprises an output opening accessible from a top of the upper busbar.
